(19) United States
(12) Patent Application Publication
(10) Pub. No.: US 2006/0079230 A1
(43) Pub. Date: Apr. 13, 2006

(54) System and methods for redundant networks

(76) Inventor: Thomas C. Russell, Murray Hill, NJ (US)

Correspondence Address: David A. Hey;The BOC Group, Inc., Legal Services-IP, 575 Mountain Ave., Murray Hill, NJ, 07974, US

(21) Appl. No.: 10/964,414

(22) Filed: Oct. 13, 2004

(51) Int. Cl. H04Q 7/20

(52) U.S. Cl. 455/434; 455/445

(57) ABSTRACT

Systems and methods for redundant data communication are presented. In some embodiments, a redundant wireless networking system includes at least two wireless access points directly associated with a wired network and configured to provide wireless network access over one or more common areas, and one or more transceivers whose locations are restricted within the common area(s). Some embodiments concern a system for providing data communications over a power line network, including a host associated with one or more power lines, where the host is configured to mange a self-configuring data communications network, and a plurality of client devices configured to communicate with the host over the power line(s) in an ad-hoc manner. Certain embodiments may have usage in industrial applications.

### FIELD OF THE INVENTION

Principles consistent with embodiments of the present invention generally relate to fault-tolerant data communication networks, and more specifically, to redundant data communication networks which may be suited for industrial applications.

### BACKGROUND OF THE INVENTION

Data communication networks are playing an increasingly larger role in industrial, commercial, and domestic applications. As greater reliance is placed upon automation technology and the ability to share information, there is a desire to have reliable networks for data communication.

In an industrial setting, industrial equipment is typically networked using wired connections for monitoring, communications, and control functionality. Conventional industrial equipment configurations may include a group of industrial controllers and a host machine, each communicating over a wired network. The host machine may act as a Human-Machine Interface (HMI) or a Supervisory Control and Data Acquisition (SCADA) system. Typical operation includes each controller providing control for a machine and/or process it is associated with, and the SCADA system providing alarming, event handling and logging, human interface functions, and supervisory control. While for some applications it may be desirable to have individual controllers communicate directly with each other over the data communications network, common configurations may utilize a simpler approach by restricting communications between the host machine and the controllers.

The wire used in the wired data communications network has physical characteristics which may depend upon the type of networking and the physical dimensions of the network. A very popular type of wired networking is known as Ethernet, which typically utilizes Transmission Control Protocol over Internet Protocol (TCP/IP) for data communications. Establishing an Ethernet network can become expensive since it usually requires installing cable, which typically increases in cost per unit length for longer cable runs, and other networking components such as routers and switches to manage data traffic. Alternatives to wired networking have recently been developed to reduce installation costs. Some of these alterative forms utilize radio waves for data communication. Some widely accepted implementations of wireless networking include variants of an IEEE 801.11 standard (collectively known as WiFi). Other alternative forms of data networking utilize an existing power distribution network for data communications, thus reducing the costs for running cable. One popular implementation of Power Line Networking (PLN) includes a standard known as HomePlug. By using one or more alternatives to wired networking, the data communications network may be simplified and implementation costs reduced.

Reliability is typically a major concern for any data communications network. A single fault in the network infrastructure such as a cable break or a faulty connection can disable the entire data communications network. Such failures may be difficult and time consuming to resolve, and further result in significant downtime costs in an industrial setting. One traditional solution for reducing the risk of network failure is to provide a fault-tolerant wired network by installing redundant cables, network interfaces, and other network components. While this approach does provide a degree of fault tolerance, it may be quite undesirable because of the significantly increased cost and complexity of the data communications network.

### SUMMARY OF THE INVENTION

In the following description, certain aspects and embodiments will become evident. It should be understood that the invention, in its broadest sense, could be practiced without having one or more features of these aspects and embodiments. It should be understood that these aspects and embodiments are merely exemplary.

Some aspects of the present invention are directed generally to fault-tolerant data communication networks, and, in some instances, to redundant networking which may use cost-effective alternatives to conventional wired data communication networks. Some aspects are alternatively (or also) directed to redundant networks for use in industrial applications.

In one aspect, as embodied and broadly described herein, a system for providing redundant wireless networking may be presented, comprising at least two wireless access points, where each of the wireless access points may be directly associated with a wired network and configured to provide wireless network access over at least one common area. The system may further comprise at least one transceiver restricted to be located within the at least one common area, where the at least one transceiver may be configured to select an individual wireless access point from the at least two wireless access points to establish a link to the wired network.

In another aspect, a system for providing redundant wireless networking may be provided, comprising a plurality of server transceivers, each directly coupled to a wired network and providing independent access to the wired network using a unique wireless channel; and at least one client transceiver having substantially continuous access to at least two of the unique wireless channels, the client transceiver being configured to select one wireless channel from the at least two unique wireless channels.

In one more aspect, a system for providing redundant wireless networking for an industrial facility may be provided, comprising at least two wireless access points, each directly associated with a wired network and configured to provide wireless network access within an industrial facility; and industrial equipment located within the industrial facility, where the industrial equipment may be configured to select an individual wireless access point from the at least two wireless access points to establish a link to the wired network.

In yet another aspect, a system for providing data communications over a power distribution network is provided, comprising a host associated with at least one power line, the host being configured to mange a self-configuring data communications network over the at least one power line; and a plurality of client devices associated with the at least one power line, each of the plurality of client devices being configured to communicate with the host over the at least one power line, wherein the system may be configured so that the communications from each one of the plurality of client devices are relayed through at least one other device of the plurality of client devices.

In a further aspect, a system for providing a data communications for industrial applications over a power distribution network is provided, comprising a host device configured to manage a self-configuring network; a plurality of client devices, communicably linked to the host device over at least one power line, wherein each of the plurality of client devices communicates with the host device using ad-hoc communication; and industrial equipment associated with at least one of the plurality of client devices.

In an even further aspect, a method for providing data communications over power lines is provided, comprising initializing data communications over a power line network through self-configuration; providing data from a source device to at least one intermediate device over the power line network; and relaying the data from the at least one intermediate device to a destination device over the power line network. The method may further comprise receiving a routing request by at least one device; storing at least one path back to a host on the at least one device; rebroadcasting another routing request from the at least one device; receiving the rebroadcasted routing request by at least one other device; and storing at least one path back to the host on the at least one other device. In addition, the rebroadcasting (and possibly also the storing) may repeat until all devices on the power line network have received a respective routing request.

One more aspect relates to a system for providing redundant networking for industrial applications, comprising a host configured to mange data communications over a power distribution network; at least two devices configured to communicate with the host over the power distribution network, where communications from each one of the devices are relayed through at least one other device of the at least two devices; at least two wireless access points directly associated with the at least two devices and configured to provide wireless network access within an industrial facility; and industrial equipment located within the industrial facility, wherein the industrial equipment may be configured to select an individual wireless access point from the at least two wireless access points to establish a data communications link to the power distribution network.

Aside from the structural and procedural arrangements set forth above, the invention could include a number of other arrangements, such as those explained hereinafter. It is to be understood, that both the foregoing description and the following description are exemplary.

### BRIEF DESCRIPTION OF THE DRAWINGS

The accompanying drawings, which are incorporated in and constitute a part of this specification, illustrate several exemplary embodiments of the invention and together with the description, serve to explain the principles of the invention.

FIG. 1 shows an exemplary redundant wireless network consistent with an embodiment of the present invention.

FIG. 2 shows an exemplary redundant wireless network having more than one common area consistent with another embodiment of the present invention.

FIG. 3 shows an exemplary redundant wireless network being used in an industrial application consistent with yet another embodiment of the present invention.

FIG. 4 shows an exemplary server transceiver consistent with some embodiments of the invention.

FIG. 5 shows an exemplary client transceiver consistent with some embodiments of the invention.

FIG. 6 shows a method consistent with some embodiments of the invention where server transceivers are configured to perform load leveling.

FIG. 7 shows an exemplary power line network consistent with another embodiment of the present invention.

FIG. 8 shows an exemplary host for a power line network consistent with some embodiments of the invention.

FIG. 9 shows a power line network being used in an industrial application consistent with another embodiment of the invention.

FIG. 10 shows an exemplary power line interface consistent with some embodiments of the invention.

FIG. 11 shows a flowchart depicting an exemplary method used for communication in a power line network.

FIG. 12 shows a flowchart depicting an exemplary method used for initializing communication in a power line network.

FIG. 13 shows an exemplary redundant wireless network used in conjunction with a power line network consistent with another embodiment of the invention.

### DESCRIPTION OF EMBODIMENTS

Reference will now be made in detail to some possible embodiments of the invention, examples of which are illustrated in the accompanying drawings. Wherever possible, the same reference symbols (and also reference symbols having identical numerals but differing alphabet suffixes) will be used throughout the drawings and the description to refer to the same or like parts.

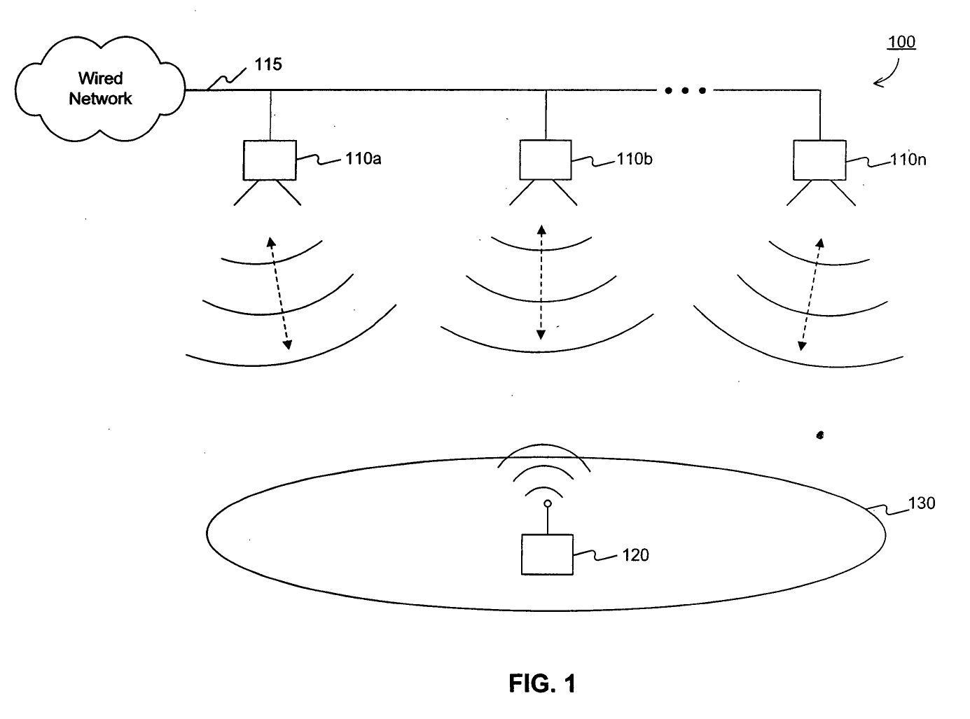

FIG. 1 shows an exemplary configuration for a redundant wireless network consistent with an embodiment of the present invention. Redundant wireless network 100 may include two or more server transceivers 110a-110n. Wireless network 100 may also include one or more client transceivers. In order to simplify the discussion, only one client transceiver 120 is shown in FIG. 1; however, any other number of client devices may be provided (e.g., the number may be a function of the capabilities of redundant wireless network 100).

Each server transceiver 110a-110n may be physically connected directly to a wired network 115 using techniques known in the art, such as, for example, TCP/IP over Ethernet. All server transceivers 110a-110n may provide wireless access coverage over common area 130. In other words, common area 130 may be a three-dimensional physical space having overlapping wireless coverage from all server transceivers 110a-110n.

Client transceiver 120 may be located anywhere within common area 130, where it may establish a wireless data connection to any server transceiver 110a-110n to obtain access to wired network 115. In at least some examples, the location of client transceiver may be restricted (e.g., fixed) to be located within the common area 130 during use of the network 100. Such an exemplary arrangement differs from an arrangement having mobile communication devices (e.g., mobile telephones) movable from one coverage zone to another.

A wireless data connection may be established by client 120 scanning for server transceivers 110a-110n and, based upon a number of different criteria described in further detail below, selecting one server transceiver for a wireless connection, and through this server obtaining access to wired network 115. If the wireless connection to the selected server transceiver is broken, client transceiver 120 may automatically scan the other server transceivers to establish another wireless connection. The ability of client transceiver 120 to scan over two or more server transceivers 110a-110n, and select any one to establish a connection to wired network 115, may provide a level of redundancy in wireless network 100 and improve the reliability of the connection between client device 120 and wired network 115.

Server transceivers 110a-110n may use any wireless networking protocol known to those of ordinary skill in the art, which may include, for example, any variant of IEEE 801.11, Bluetooth, etc. Client transceiver 120 may also use any wireless protocol in common with server transceivers 110a-110n, such as, for example, IEEE 801.11, Bluetooth, etc., to communicate wirelessly with server transceivers 110a-110n. Client transceiver 120 is typically stationary, but it may also be movable anywhere within common area 130 to establish a wireless connection with any server transceiver 110a-110n.

The size of common area 130 may depend upon a number of factors, such as the type of wireless networking protocol being used, the amount of transmitting power available to server transceivers 110a-110n and client transceiver 120, the antenna characteristics and orientation of server transceivers 110a-110n and client transceiver 120, etc. In one non-limiting example, common area 130 may extend over an area of about 20 ft.×about 20 ft. and have a height at least slightly less than that of a ceiling of a room in which transceivers 110a-110n and 120 may be situated. One skilled in the art will appreciate that the location of server transceivers 10a-110n may vary from installation to installation. In some examples, a RF survey may be performed to determine suitable locations for server transceivers 110a-110n.

Further referring to FIG. 1, server transceivers 110a-110n may function as wireless access points operating in an infrastructure mode. As used herein, the term “wireless access point” is defined as a device which can provide a connection between a wired data network and another device which is not physically connected to the wired data network, by using a wireless connection. The term “infrastructure mode” may refer a mode of communications whereby devices, which are wirelessly connected to a wireless access point, may communicate with other wireless devices or a wired network only through the wireless access point. Each server transceiver 110a-110n may be assigned a fixed channel identification code which is unique within wireless network 100. Fixed channel assignment may be performed by a user at each server transceiver, or performed remotely over wired network 115 by a user through a computer. Alternatively, the channel identification codes may be dynamically assigned by an external controller (not shown) connected to wired network 115, such as, for example, a computer. Channel identification codes may also be dynamically assigned by server transceivers 110a-110n themselves. In such an example, server transceivers 110a-110n could communicate with each other to determine what channel identification codes are available. Software running on-board each server transceiver would control the channel assignments.

In one embodiment, upon powering on, a server transceiver could select the first channel available from a channel list. If the first channel is in use, then the server transceiver may select the next channel in the channel list, and check whether that channel is in use. If so, then the processing returns to checking whether the next channel is in use. If the channel is not in use, then, after waiting for a random time, for example, a few seconds, the server transceiver may check whether the previously available channel is still available (i.e., still not in use), and if so, the server transceiver may begin operating on the channel. Otherwise, the server transceiver may select the next channel on the channel list and repeat the aforementioned steps until it can begin operating on an available channel. Each server transceiver may thus iteratively search for the next available channel on the channel list until a channel that is not being used is found.

Alternatively, upon powering on, a server transceiver may broadcast a query to all other server transceivers in reach. Each of the other server transceivers may respond with the channel number it is using along with the channel numbers of neighboring server transceivers. The server transceiver may then select a channel that is not in use by the neighboring server transceivers. After selecting the channel, the server transceiver may broadcast the selected channel number to the neighboring transceivers, such that they may update their list of channels that are in use.

Further referring to FIG. 1, once each of server transceivers 110a-110n is assigned a unique channel identification code, client transceiver 120 has access to all of the channels associated with server transceivers 110a-110n, and may automatically scan all of the associated channels and select one server transceiver to establish a wireless data connection. Client transceiver 120 may base this selection on techniques which are well known in the art, and which are used, for example, in commercially available IEEE 801.11 products. Such techniques may also include sequentially scanning for signals associated with each channel identifier code and selecting the first one having a signal whose strength meets a predefined threshold. Alternatively, client transceiver 120 could base a channel selection upon choosing a signal which maximizes one or more signal characteristics. Such characteristics could include, for example, maximum signal strength, maximum signal quality, and/or the signal having the lowest bit error rate.

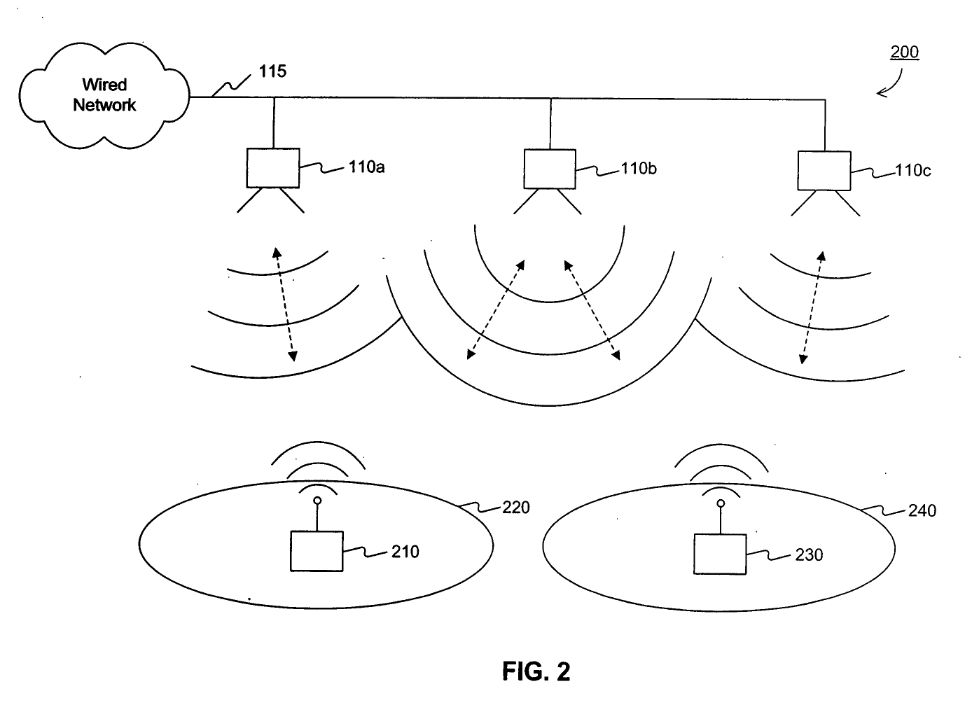

FIG. 2 shows another embodiment consistent with the present invention having more that one common area. For purposes of explanation only, FIG. 2 depicts a redundant wireless network 200 having three server transceivers 110a-110c, two client transceivers 210, 230, and two separate common areas 220, 240. (One of ordinary skill in the art would appreciate that alternative embodiments may have a greater number of server transceivers, client transceivers, and common areas than are shown in FIG. 2.) As shown in FIG. 2, the two common areas 220, 240 may cover differing physical areas which may have no overlap (or alternatively, no greater than a partial overlap). Server transceivers 110a and 110b provide redundant wireless access over common area 220. Client transceiver 210 has access to server transceivers 110a and 110b, and can select either one for obtaining data communication access to wired network 115. This selection occurs in the same manner as described above in the embodiment shown in FIG. 1. Server transceivers 110b and 110c provide redundant wireless access over common area 240. Client transceiver 230 has access to server transceivers 110b and 110c, and can select either one for obtaining data communication access to wired network 115. As before, this selection occurs in the same manner as described above in the embodiment shown in FIG. 1. In this embodiment, separate common areas 220 and 240 share wireless access with server transceiver 110b. The sharing arrangement in this embodiment may have the advantage of providing redundant wireless access over a larger area while reducing the number of server transceivers. The relative placement of common areas 220 and 240 may depend upon the positioning of server transceivers 110a-110b and their respective antenna orientations.

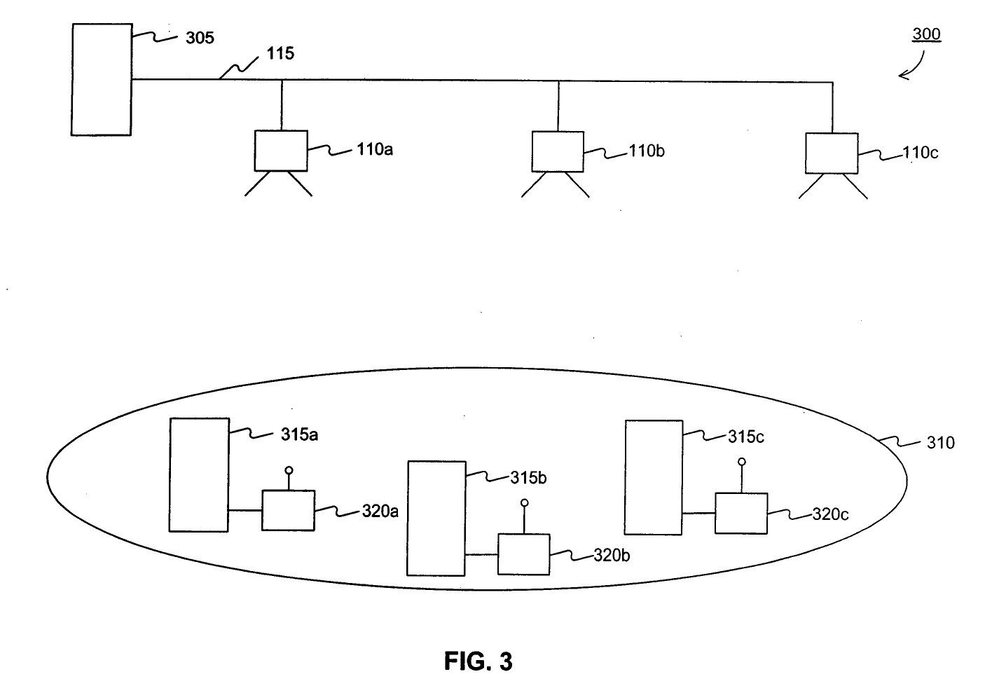

FIG. 3 shows another embodiment consistent with the present invention for use in an industrial application. For purposes of explanation only, FIG. 3 depicts a redundant wireless network 300 having three server transceivers 110a-110c and three client transceivers 320a-320c associated with respective industrial devices 315a-315c. (One of ordinary skill in the art would appreciate that alternative embodiments may have a different number of server transceivers, client transceivers, and industrial devices than are shown in FIG. 3.) Controller 305 may be connected to server transceivers 110a-110c over wired network 115. Through redundant wireless network 300, controller 305 may communicate with industrial devices 315a-315c. Controller 305 may be a SCADA system which can provide alarming, event handling and logging, human interface functions, and supervisory control for industrial devices 315a-315c. The SCADA may be, for example, a personal computer running specialized software, a custom digital controller, etc. Industrial devices 315a-315c interface to client transceivers 320a-320c, respectively, for communication with controller 305. Client transceivers 320a-320c are placed within common area 310.

One of ordinary skill in the art would appreciate that a client transceiver could interface to more than one industrial device using the appropriate controller or networking equipment, such as, for example a router or switch. This interface may be external, and use a standard networking interface, such as, for example, TCP/IP over Ethernet. Alternatively, the client device may be physically incorporated into the industrial equipment, and the interface may be internal, such as for example, Peripheral Component Interface (PCI). Regardless of the interface, client transceivers 320a-320c may communicate in wireless, redundant manner using server transceivers 110a-110c as described above for the embodiment shown in FIG. 1. Wireless network 300 and common area 310 may be placed in any type of industrial facility, including, for example, facilities for manufacturing/processing semiconductors, pharmaceuticals, automobiles, food, etc. Industrial devices 315a-315c may be configured to be used for virtually any industrial application, including, for example, semiconductor fabrication, pharmaceutical manufacturing, automobile manufacturing, food processing, etc. For example, one or more of industrial devices 315a-315c may be a pump, such as a pump configured for use in any of the industrial applications mentioned above.

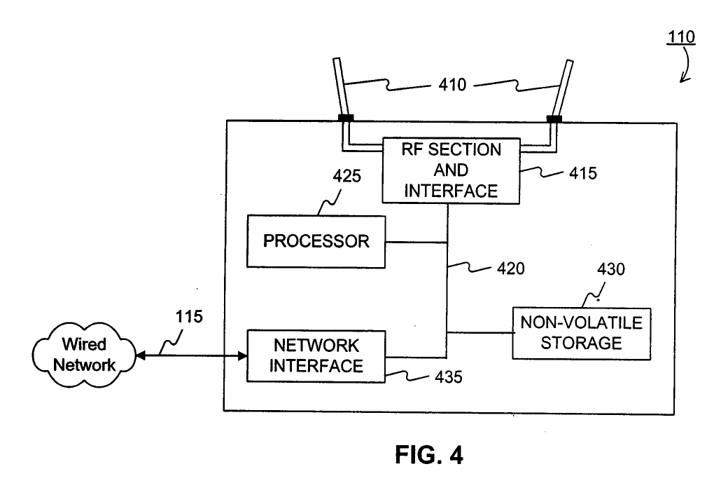

FIG. 4 shows an exemplary server transceiver 110 consistent with some embodiments of the invention. Server transceiver 110 may use any type of wireless networking protocol, such as, for example variant(s) of IEEE 801.11, and may be of the type such as those manufactured by Linksys of Irvine, Calif., D-Link Systems, Inc. of Fountain Valley, Calif., or Netgear, Inc. of Santa Clara, Calif. Radio frequency signals which can be encoded with digital data may be transmitted and received through antenna configuration 410. (The antenna configuration may be any known configuration, and the configuration displayed in FIG. 4 is merely exemplary.) The radio signal may be processed and converted to a digital format by an RF Section and Interface 415 for transmission over bus 420. Processor 425 controls server transceiver 110 and digitally processes the digital data according to instructions stored in non-volatile storage 430. A Network interface 435 may send and receive digital communications data over wired network 115. Wired network 115 may be any type of known network which communicates over a physical connection, and could include, for example, TCP/IP over Ethernet.

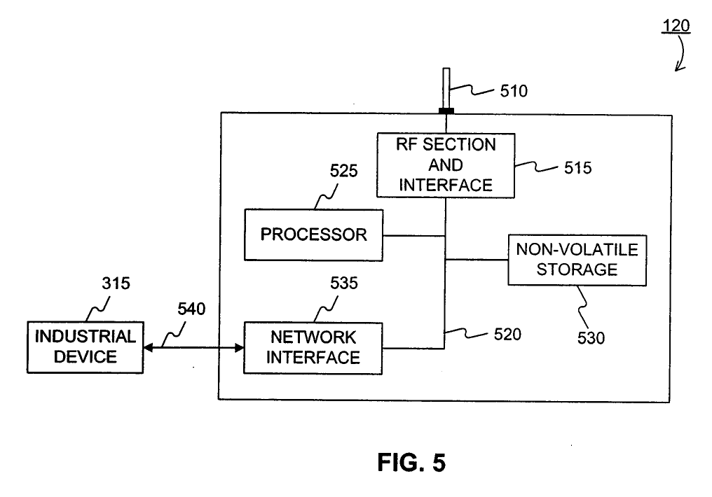

FIG. 5 shows an exemplary client transceiver 120 consistent with some embodiments of the invention. Client transceiver 120 may use any type of wireless networking protocol consistent with server transceiver 110, and may be, for example, manufactured by Linksys, D-Link Systems, Inc., or Netgear, Inc. Radio frequency signals, which can be encoded with digital data, may be transmitted and received through antenna 510. As in FIG. 4, the configuration displayed in FIG. 5 is merely exemplary. The radio signal may be processed and converted to a digital format by an RF Section and Interface 515 for transmission over bus 520. Processor 525 controls client transceiver 120 and digitally processes the digital data according to instructions stored in non-volatile storage 530. A Network Interface 535 may send and receive digital communications data over connection 540 to/from industrial device 315. As mentioned above, client transceiver 120 may be physically external to industrial device 315, and connection 540 may be a network connection known to those of ordinary skill in the art, such as, for example TCP/IP over Ethernet. Alternatively, client transceiver 120 may be physically incorporated into industrial device 315, in which case connection 540 may be a card-type interface such as PCI, and client device may take the form of a standard wireless network card.

In order to prevent a server transceiver from bearing a disproportionate amount of the network load, each client transceiver may be manually configured to use a preferred channel. In such an example, the client transceiver may first try to use the preferred channel and, if it is not available, scan the other channels to find another available server transceiver.

An alternative approach to prevent a plurality of client transceivers from overloading a server transceiver is to perform load leveling. In one example, each of the client transceivers can be configured to scan the channel identifiers in a differing sequence and select the channel based upon the criteria previously described in the embodiment shown in FIG. 1.

Alternatively, load leveling may be performed by an external controller connected to wired network 115, wherein the controller may monitor the amount of data traffic flowing through each server transceiver 110, or it may simply determine how may client transceivers are connected. If the controller determines that one server transceiver is bearing a disproportionate amount of the network load, the controller may reassign each of the channels to one or more of the server transceivers.

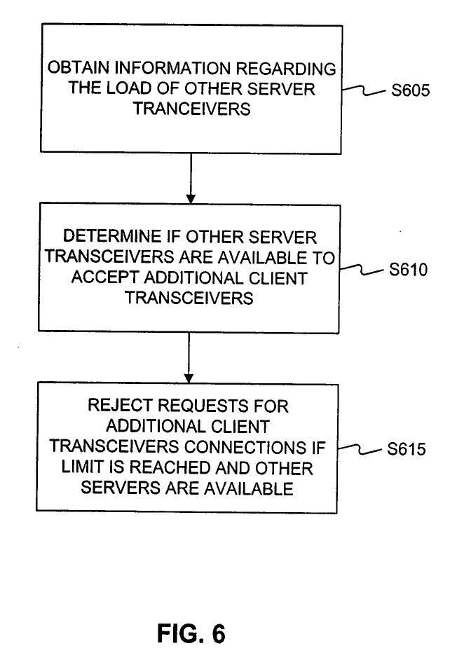

FIG. 6 depicts a method consistent with some embodiments of the present invention where server transceivers 110 are configured to perform load leveling. Processor 425 in each server transceiver 110 can be configured to perform the method of FIG. 6 using software stored in nonvolatile memory 430. The method may include obtaining information regarding the load of other server transceivers (S605). (For example, with respect to transceiver 110a of FIG. 1, obtaining information regarding the load of transceivers 110b-110n.) This may be done by monitoring the amount of data flowing through each other server transceiver, or by determining the number of client transceivers connected to each other server transceiver 110. The method may also include determining if other server transceivers are available to accept additional client transceivers (S610). Further, the method may include rejecting requests for additional client transceivers connections if a limit has been reached and other transceivers are available (S615). Moreover, in order to facilitate load leveling, processor 425 in each client transceiver may change the channel identification code for its server transceiver 110.

As described above, data communications over power distribution networks, defined herein as Power Line Networking (PLN), may be used as an alternative to more conventional networking techniques, such as, for example, TCP/IP over Ethernet. As used herein, a power distribution network may be defined as an interconnected structure of power lines, interfaces, relays, circuit panels, protective devices, and a wide variety of other components known to those of ordinary skill in the art, for delivering electrical power.

In some instances, power distribution networks can be highly complex and span large geographic areas. Some power distribution networks may contain a large number of branches and interconnects which may create reflections and noise issues for some high-speed data communications. Moreover, because some power distribution networks may use relatively low frequency AC signals, their associated power lines may not be adequately shielded to protect higher frequency communication signals from external interference.

Despite any potential disadvantages, PLN may be desirable because devices benefiting from networking may be supplied with external power from the power distribution network. Accordingly, the power distribution network has the potential to provide an established, low cost infrastructure for data communications.

As described above, the HomePlug standard may allow Ethernet compliant devices to communicate over a PLN. HomePlug's operation, however, may be restricted to distances over the power distribution network which could limit effective operation in many scenarios, including some industrial applications. Moreover, certain equipment (e.g., large motors) used for particular industrial applications may cause additional noise over the power distribution network, potentially reducing the effectiveness of HomePlug operation.

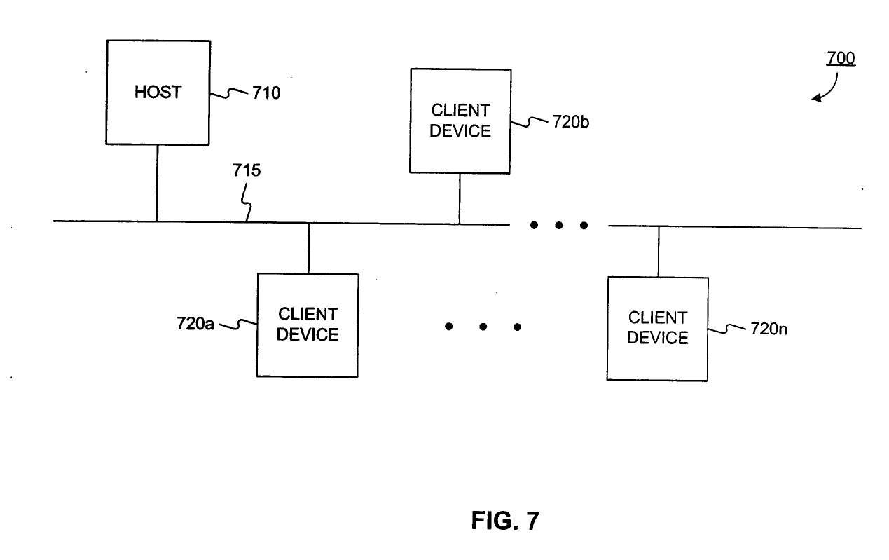

FIG. 7 shows an exemplary PLN 700 consistent with another embodiment of the present invention. PLN 700 may include a host 710 and a plurality of client devices 720a-720n, which are all connected to a power line 715. Host 710 may receive power and communicate with client devices 720a-720n via the power line 715. Power line 715 may be part of a larger power distribution network (not shown).

Communication may take place between host 710 and client devices 720a-720n in an ad-hoc fashion. (One of ordinary skill in the art would appreciate that the invention does not preclude client devices 720a-720n exchanging data with each other, either directly or through host 710.) As used herein, “ad-hoc” communication describes a mode of communication whereby each of client devices 720a-720n may relay data through other client devices until the data reaches an intended recipient. In some examples, ad-hoc refers to the ability of one client device to communicate directly with another client device without the data going through an access point. When client devices not only communicate with each other, but also act as access points to forward data, then this is called a mesh network. In a mesh network, if a client device A wants to send a message to a client device C, it may first pass the message to a client device B who then sends the message to the client device C. By using ad-hoc communication, data communications over power line 715 may possibly extend over much greater distances than that obtained using conventional power line networking techniques. The communication process over PLN 700 will be described in more detail below.

In some examples, PLN 700 may be self-configuring. As used herein, “self-configuring” may be defined as utilizing a procedure for systematizing PLN 700 to perform data communications in an automated and dynamic manner. Through self-configuration, PLN 700 may be able to adapt to changing conditions of a data communications network, such as, for example, the addition or removal one or more client devices 720a-720n.

Self-configuration may be initiated by host 710 broadcasting a routing request to client devices 720a-720n. This broadcast may occur on a periodic basis or, in the event that host 710 fails to receive an expectant message, from one or more client devices 720a-720n. As used herein, the term “broadcast” may be defined as the process of sending a message to all available recipients (e.g., client devices 720a-720n) connected to PLN 700.

All client devices 720a-720n which may be in reception range of host 710 (e.g., in direct contact with host 710 through power line 715) may receive an initial routing request broadcasted by host 710 and store the address of host 710. Then, at least some (i.e., all or less than all) of client devices 720a-720n may rebroadcast the routing request for other client devices 720a-720n which did not receive the initial broadcast from the host 710. These other client devices may receive the rebroadcasted routing request and store the address of the sender client device which corresponds to a hop back in the direction of host 710.

As used herein, the term “path” may be used to denote the entire route a message takes, from sender to recipient, over PLN 715. The term “hop” may be used to describe one segment within a path, wherein a segment is a direct route between two client devices, or a direct route between a client device and host 710. In this type of communications, the client device may only store the address of one or more client devices back in the direction of the host.

If a client device 720a-720n receives more than one routing request, it may record the address of a sender client device corresponding to the first routing request received. Alternatively, it may record the address of the sender client device having the strongest routing request signal. This process may repeat itself until all of client devices 720a-720n within PLN 700 store their respective first hop back to host 710. Each of client devices 720a-720n may send back an acknowledgement message to host 710 in response to the routing request and append addressing information. As acknowledgement messages are relayed back to the host 710, each relaying client device may append its own address information. Once an acknowledgement message is received at the host 710, the appended address information represents a path to client devices 720a-720n, and may be stored in a routing list so host 710 may contact each of client devices 720a-720n.

In at least some examples, placement of client devices 720a-720n in the appropriate areas of PLN 700 may achieve a level of fault tolerance by establishing redundant paths in the power line network. The efficiency of the redundant power line network may be enhanced by programming host 710 to build the routing list to include multiple paths to each of client devices 720a-720n. In this manner, if host 710 cannot reach a particular client device using one path, another path may be selected from the routing list to send a message.

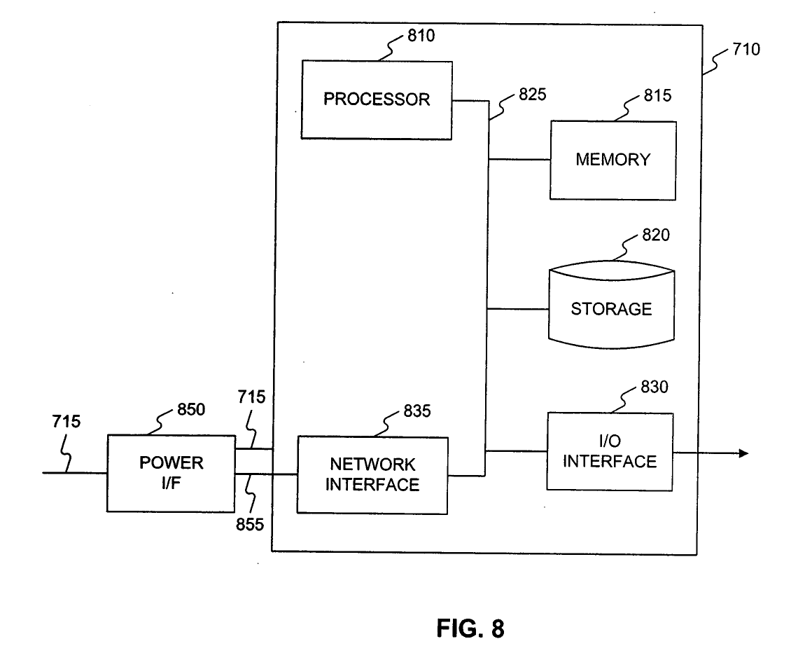

FIG. 8 shows an exemplary host 710 for PLN 700 consistent with some embodiments of the invention. Host 710, which may be a personal computer, or any other type of controller known to one of ordinary skill in the art, may manage communications over PLN 700, and control and/or monitor client devices. Host 710 may be, for example, a SCADA as described above. Host 710 may include a processor 810 which may execute instructions for managing PLN 700, and for controlling and/or monitoring client devices connected to PLN 700. Instructions and data may be stored in a memory 815 and/or storage 820 and passed over a bus 825 to and from processor 810. Exemplary types of data stored in memory 815 and/or storage 820 storage could include routing lists and other network configuration data. An I/O interface 830 may be used to exchange data with user interface devices, such as displays, keyboards, and the like. A network interface 825, may be used to prepare data for transport using a standard set of protocols, such as, for example TCP/IP, and may communicate with processor 810 over bus 825.

A power interface 850 prepares data for transport over power line 715. Power interface 850 may modulate the power line signal with the data using techniques known to those of ordinary skill in the art, such as, for example, methods similar to the HomePlug standard. As shown in FIG. 8, power interface 850 may be external to host 710, or it may be incorporated into host 710 (not shown). As an external device, power interface 850 may exchange data with network interface 835 using standard techniques, such as, for example, TCP/IP over Ethernet. Power Interface 850 may also have a feed-through for power line 715 to provide power to host 710.

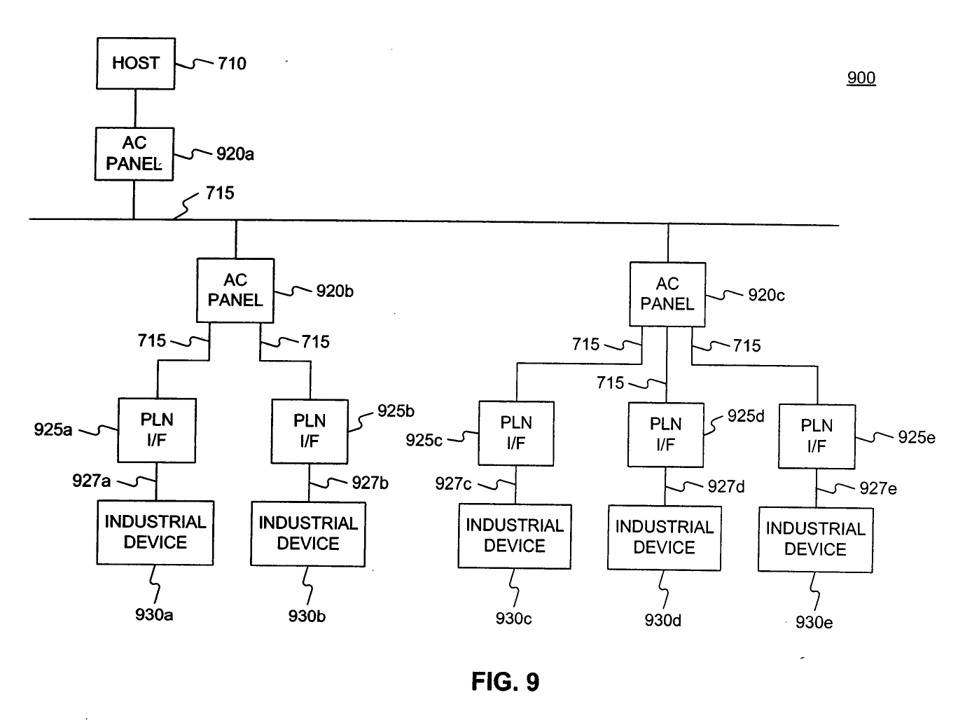

FIG. 9 shows an exemplary Power Line Network (PLN) 900 being used in an industrial application consistent with some embodiments of the invention. Host 710 may be connected to power line 715 through an AC panel 920a. One skilled in the art will appreciate, that in this example, power interface is incorporated into host 710, although it may be external to host 710. AC panel 920b interfaces industrial devices 930a and 930b to power line 715 through PLN Interfaces (PLNI) 925a and 925b, respectively. AC panel 920c interfaces industrial devices 930c, 930d, and 930e to power line 715 through PLNIs 925c, 925d, and 925e, respectively. AC panels 920a, 920b, and 920c may be a collection of electrical distribution circuits including relays, circuit breakers, and/or safety devices, and each may be wired in an appropriate configuration for supplying electrical power to their connected host (in the case of panel 920a) or industrial devices (in the case of panels 920b and 920c).

PLNIs 925a-925e may be used for managing power line data communications for their respective industrial devices 930a-930e, including, for example, relaying and/or acknowledging messages as appropriate. PLNIs 925a-925e may interface to respective industrial devices 930a-930e using a respective standard interface 927a-927e, such as, for example, TCP/IP over Ethernet. Exemplary PLNIs 925a-925e are discussed in detail below.

PLN 900 may be used in any type of industrial facility, including, for example, facilities for manufacturing/processing semiconductors, pharmaceuticals, automobiles, food, etc. Industrial devices 930a-930e may be configured to be used for virtually any industrial application, including, for example, semiconductor fabrication, pharmaceutical manufacturing, automobile manufacturing, food processing, etc. For example, one or more of industrial devices 930a-930e may be a pump, such as a pump configured for use in any of the industrial applications mentioned above.

Further referring to FIG. 9, the following describes an exemplary method of providing communication between host 710 and industrial devices 930a-930e. When host 710 sends a message to industrial devices 930a-930e, it may send the message along a path specified by the routing list. For example, host 710 may want to command industrial devices 930a and 930e to shut down. Because the path to industrial device 930a is short, the shutdown message may be sent directly to industrial device 930a, without relaying it through any other industrial devices. Regarding industrial device 930e, host 710 may route the shutdown command through several PLNIs, as specified by the routing list, to reach industrial device 930e. For example, the message from host 710 may be relayed through PLNIs 925b and 925c before it reaches PLNI 925e. In some examples, routing of a message, such as the shut down command may include each of the successive PLNIs 925b and 925c, for example, re-broadcasting the same message, to the next PLNI in the routing list. Thus, for example, when PLNI 925b receives the shut down command intended for PLNI 925e, it may simply rebroadcast the shut down command to PLNI 925c. Once the destination PLNI, such as PLNI 925e acknowledges receipt of the message, host 710 need not resend or rebroadcast the message. Alternatively, when host 710 commands industrial devices 930a and 930e to shut down, it may broadcast the shutdown message over the entire PLN 900, along with the addresses of industrial devices 925a and 925e, so the message may be relayed to them like a routing request.

When one or more of industrial devices 930a-930e sends a message to host 710, it may provide the message through the respective networking interface 927a-927e to respective local PLNI 925a-925e. If it is within direct range, the local PLNI may relay the message through the first hop back to host 710. If the local PLNI is beyond the direct range, the message may be relayed through other PLNIs before it reaches host 710. For example, when industrial device 930e wants to contact host 710, it may send a message through its respective PLNI 925e via connection 927e, which may relay the message through a hop to PLNI 925c. PLNI 925c may in turn relay the message through PLNI 925b, which may relay the message back to host 710.

In the PLN 900, communications may be exchanged between host 710 and the industrial devices 930a-930e. Additionally (or alternatively), industrial devices 930a-930e may exchange data with each other. In some examples, at least some of industrial devices 930a-930e may exchange messages with each other through host 710. In one embodiment, to communicate through host 710, any one of industrial devices 930a-930e may send a message to host 710 with a field containing the identity of the desired recipient. Host 710 may re-broadcast the message with the desired recipient as the addressee and acknowledge its re-broadcast to the sender. Further, some examples may permit at least some of industrial devices 930a-930e to exchange messages by broadcasting them to one or more other devices, and then having them sent to one or more further industrial devices by relaying them through PLN 900. For example, any one of the industrial devices 930a-930e may communicate directly with any of the other industrial devices by broadcasting a message containing the intended recipient's address. The other industrial devices may re-broadcast the message if they are not the intended recipients. In one embodiment, a possibly large number of broadcasts may be controlled by limiting a count of re-broadcasts by each device to some number n, for example. Further, in one embodiment, once the intended recipient receives the message, it may broadcast a “kill” message indicating to the other clients to stop re-broadcasting that message.

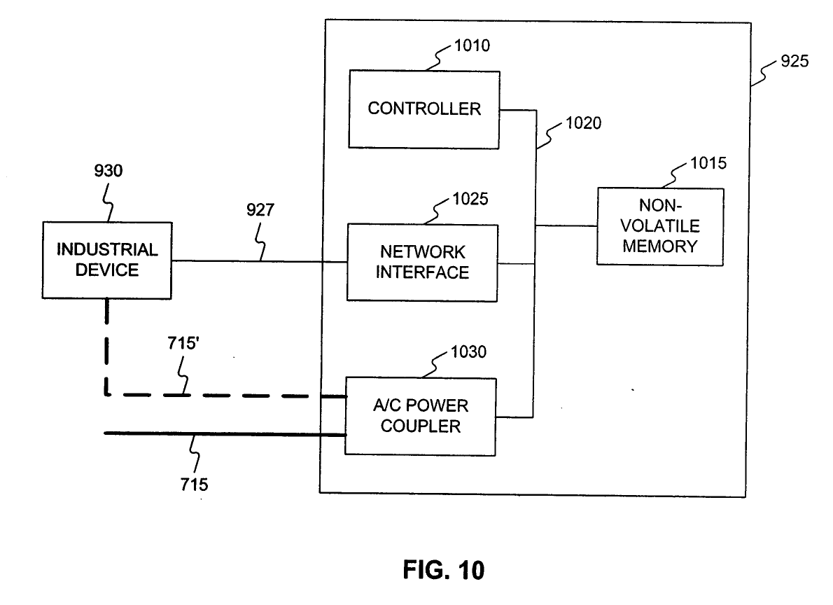

FIG. 10 shows an exemplary Power Line Networking Interface (PLNI) 925 consistent with some embodiments of the invention. A power signal having a superimposed network data signal may be carried over power line 715, and may interface to A/C Power Coupler 1030. A/C Power Coupler 1030 may extract the network data signal from the signal carried over power line 715, or superimpose the network data signal onto the signal carried over power line 715. Processing for this extraction/superposition operation may be aided by a controller 1010, which interfaces to A/C Power Coupler 1030 over a data bus 1020. Extracting/superimposing the data signal from/onto the power signal may be accomplished by using techniques known to those of ordinary skill in the art, and may include, for example, techniques used in HomePlug.

A network interface 1025 may send and receive the extracted data over connection 927 to/from industrial device 930 over network connection 927. Network connection 927 may be a standard networking interface known in the art, such as, for example, TCP/IP over Ethernet. A/C Power Coupler 1030 may optionally have a power feed 715′ to provide power to industrial device 930.

Controller 1010 may manage data communications using instructions stored in a non-volatile memory 1015 provided over bus 1020. Non-volatile memory 1015 may be used to store information regarding the configuration of the network. For example, non-volatile memory may include an address for the hop back to host 710, as described above.

As shown in FIG. 9, PLNI 925a-925e is external to its respective industrial device 930a-930e. Alternatively, PLIN 925a-925e may be physically incorporated into its respective industrial device 930a-930e, in which case its respective connection 927a-927e may be a card-type interface such as, for example, PCI card or PCMCIA card, and PLNI may take the form of a standard PCI card or PCMCIA card. One skilled in the art will appreciate that instead of a separate card-type interface, connection 927a-927e may be integrally formed on an industrial device control board associated with any one of industrial devices 930a-930e.

Power line 715 may use any electrical standard know to one of ordinary skill in the art. For example, power line 715 may carry single phase alternating current power, or it may carry three-phase alternating power. A/C Power Coupler 1030 may be configured to accept either type of power. Since three-phase power is sometimes used for machinery found in industrial settings, it could be used to send and receive communications data using all of the three lines corresponding to each phase. Alternatively, only one line of the three may be used to carry communications data. The selection of the line may be determined manually using PLNI 925a-925e. This selection could be initiated by an operator using a switch located on PLNI 925a-925e, or the phase may be selected remotely over the PLN 900, initiated manually or automatically using host 710. PLNI 925a-925e may also include indicators informing the operator which of the three phases is being used for data communication.

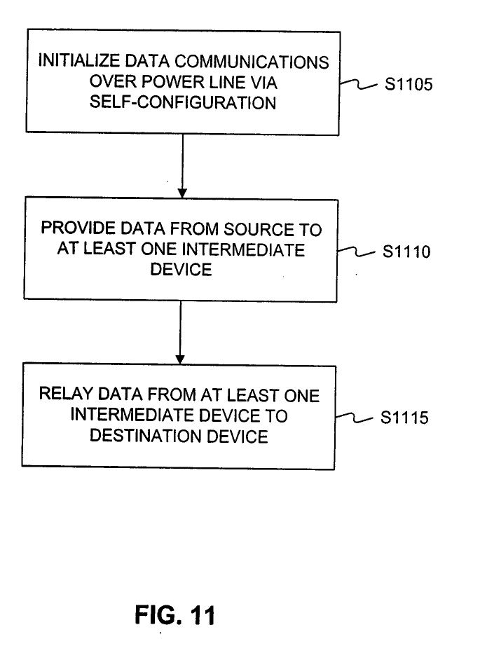

FIG. 11 shows a flowchart depicting an exemplary method for communication in a power line network consistent with some embodiments of the invention. The following describes that method in connection with the embodiment of FIG. 7, but it should be understood that the method could be practiced using alternative configurations. The host 710 and client devices 720a-720n initialize data communications over PLN 700 through self-configuration (S1105). A source device, which could be either host 710 or any client device 720a-720n, may send a data message through at least one intermediate client devices 720i (S110). The intermediate client device(s) 720i may relay the message to the destination device, which may be either any client device 720a-720n or host 710 (S115).

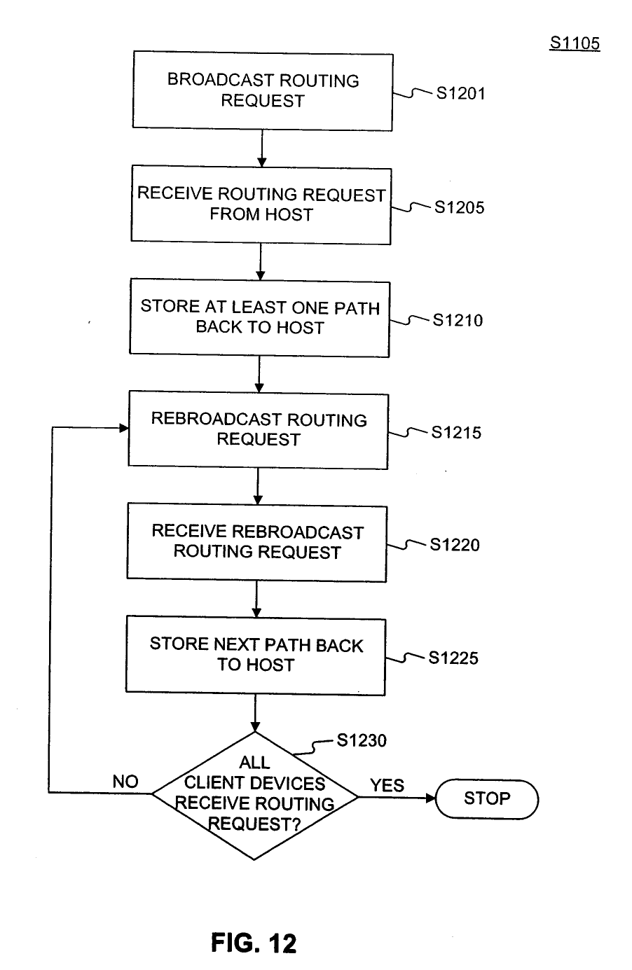

FIG. 12 shows a flowchart depicting an exemplary method for initializing communication in a power line network consistent with embodiments of the invention. The self-configuration process starts with host 710 broadcasting a routing request (S1201). Proximate client devices within range of host 710 receive the routing request (S1205). Proximate client devices store the address corresponding to one hop back to host 710 (S1210). Proximate client devices rebroadcast the routing request to a next set of client devices (S1220). The next set of client devices store the address of the sending proximate client devices which correspond to one hop back toward host 710 (S1225). This process repeats until all client devices 720a-720n have received the routing request (S1230). In one embodiment, after each client device (any one of 720a-720n, for example) receives a message from host 710, the client device acknowledges the receipt of the message back to host 710 using routing information provided with the message. This, may allow host 710 to construct a routing table. Rebroadcast of the routing request by a client device can be stopped after the client device has rebroadcast the routing request for a certain predetermined number of times. Alternatively, a client device can broadcast the routing request to only those client devices which have received the routing request before them. Thus, for example, when a client device re-broadcasts the routing request, it increments a counter and rebroadcasts the incremented counter. When a client device receives the routing request, it looks at the counter and if is higher than one recently received (e.g., received within a few seconds or any other appropriate time measure), it just ignores it. Alternatively, the routing request may also include a message identifier, such that the client device knows when it receives the same routing request twice.

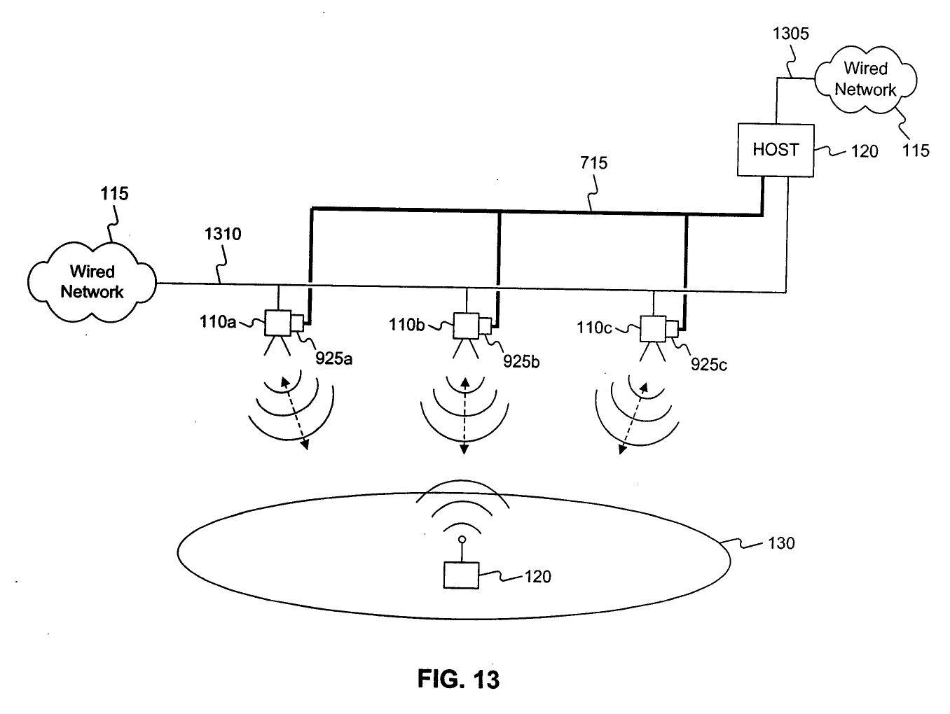

FIG. 13 shows an exemplary combination network 1300 which utilizes a redundant wireless network in conjunction with a power line network for additional redundancy. In this embodiment, server transceivers 110a-110c may have a redundant physical connection to wired network 115. Server transceivers' primary physical connection to wired network 115 is through network line 1310, similar to the embodiment shown in FIG. 1 described above. As described for FIG. 1, server transceivers 110a-110c provide redundant wireless access to client device 120 which is located in common area 130.

Server transceivers 110 may also have a redundant backup connection to wired network 115 by utilizing a power line network. The power line network is similar to the embodiment shown in FIG. 7 and is described above. Each server transceiver 110a-110c is coupled to power line interfaces 925a-c, respectively, which in turn interface to power line 715. Power line 715 provides electrical power to server transceivers 110a-110c.

Host 710 may be configured to receive data over power line 715, and in-turn access wired network 115 through an alternative network line 1305. Host 710 may monitor the state of network line 1310, and if a failure occurs, host 710 can be programmed to switch the affected server transceivers to communicate over power line 715. The affected server transceivers would then access wired network 115 through host 710 via network line 1305. This switchover may occur automatically so that client 120 may maintain a substantially continuous access to wired network 115.

It will be apparent to those skilled in the art that various modifications and variations can be made to the structure and methodology of the present invention. Thus, it should be understood that the invention is not limited to the examples discussed in the specification. Rather, the present invention is intended to cover modifications and variations.

What is claimed is:

1. A system for providing redundant wireless networking, comprising:
at least two wireless access points, each of the at least two wireless access points being directly associated with a wired network and configured to provide wireless network access over at least one common area; and
at least one transceiver restricted to be located within the at least one common area, wherein the at least one transceiver is configured to select an individual wireless access point from the at least two wireless access points to establish a link to the wired network.

2. The system according to claim 1, wherein each of the at least two wireless access points has a unique fixed identifier.

3. The system according to claim 2, wherein the at least one transceiver is configured to sequentially scan the unique fixed identifiers.

4. The system according to claim 1, wherein the at least one transceiver is configured to select the individual wireless access point based upon at least one of greatest signal strength, greatest signal quality, and lowest bit-error rate.

5. The system according to claim 1, wherein the at least two wireless access points and the at least one transceiver are configured to communicate using an I.E.E.E. 801.11 wireless networking protocol.

6. The system according to claim 1, wherein the at least two wireless access points and the at least one transceiver are configured to communicate using a Bluetooth wireless networking protocol.

7. The system according to claim 1, wherein the wired network utilizes an Internet Protocol.

8. The system according to claim 1, further comprising industrial equipment associated with the at least one transceiver.

9. The system according to claim 8, wherein the industrial equipment is equipment associated with one of semiconductor fabrication, pharmaceutical manufacturing, automobile manufacturing, and food processing.

10. The system according to claim 8, wherein the industrial equipment comprises a pump.

11. The system according to claim 8, wherein the common area is an area of a semiconductor fabrication facility.

12. The system according to claim 2, further comprising:
a plurality of transceivers, wherein each of the transceivers is configured to perform load leveling by scanning the identifiers in a different numerical sequence and selecting a unique identifier based upon a condition.

13. The system according to claim 2, further comprising:
a plurality of transceivers, wherein each of the transceivers has a preferred unique identifier which is predetermined.

14. The system according to claim 1, wherein the system further comprises a controller associated with the wired network, wherein the controller manages the at least two access points.

15. The system according to claim 14, wherein the controller performs load leveling among the at least two wireless access points.

16. The system according to claim 15, wherein the at least two wireless access points are each assigned a unique identifier which is managed by the controller.

17. The system according to claim 1, wherein each of the at least two wireless access points performs load leveling.

18. The system according to claim 17, wherein each of the at least two wireless access points further comprises:
a memory containing instructions; and
a processor executing the instructions for:
providing information regarding a number of transceivers connected to other wireless access points;
determining whether another wireless access point is available for additional transceiver connections; and
rejecting requests for additional transceiver connections if a preset number of transceivers has been reached and if at least one other wireless access point is available for additional transceiver connections.

19. The system according to claim 18, wherein the at least two wireless access points are each assigned a unique identifier which is controlled by the processor.

20. A system for providing redundant wireless networking, comprising:
a plurality of server transceivers, each of the server transceivers being directly coupled to a wired network and providing independent access to the wired network using a unique wireless channel; and
at least one client transceiver having substantially continuous access to at least two of the unique wireless channels, the at least one client transceiver being configured to select one wireless channel from the at least two unique wireless channels.

21. The system according to claim 20, wherein the at least one client transceiver is configured to sequentially scan the unique wireless channels.

22. The system according to claim 20, wherein the at least one client transceiver is configured to select the one wireless channel based upon at least one of greatest signal strength, greatest signal quality, and lowest bit-error rate.

23. The system according to claim 20, wherein the plurality of server transceivers and the at least one client transceiver are configured to communicate using an I.E.E.E. 801.11 wireless networking protocol.

24. The system according to claim 20, wherein the plurality of server transceivers and the at least one client transceiver are configured to communicate using a Bluetooth wireless networking protocol.

25. The system according to claim 20, wherein the wired network utilizes an Internet Protocol.

26. The system according to claim 20, further comprising industrial equipment associated with the at least one client transceiver.

27. The system according to claim 26, wherein the industrial equipment is equipment associated with one of semiconductor fabrication, pharmaceutical manufacturing, automobile manufacturing, and food processing.

28. The system according to claim 26, wherein the industrial equipment comprises a pump.

29. The system according to claim 26, wherein the client transceiver is located in an area of a semiconductor fabrication facility.

30. The system according to claim 21, further comprising:
a plurality of client transceivers, wherein each of the client transceivers is configured to perform load leveling by scanning the channels in a different numerical sequence and selecting a unique channel based upon a condition.

31. The system according to claim 21, further comprising:
a plurality of client transceivers, wherein each of the client transceivers has a preferred unique channel which is predetermined.

32. The system according to claim 20, wherein the system further comprises a controller associated with the wired network, wherein the controller manages the plurality of server transceivers.

33. The system according to claim 32, wherein the controller performs load leveling among the plurality of server transceivers.

34. The system according to claim 33, wherein the plurality of server transceivers are each assigned a unique channel which is managed by the controller.

35. The system according to claim 20, wherein each of the plurality of server transceivers performs load leveling.

36. The system according to claim 35, wherein each of the plurality of server transceivers further comprises:
a memory containing instructions; and
a processor executing the instructions for:
providing information regarding a number of client transceivers connected to other server transceivers;
determining whether another server transceiver is available for additional client transceiver connections; and
rejecting requests for additional client transceiver connections if a preset number of client transceivers has been reached and if at least one other server transceiver is available for additional client transceiver connections.

37. The system according to claim 36, further wherein the plurality of server transceivers are each assigned a unique channel which is controlled by the processor.

38. A system for providing redundant wireless networking for an industrial facility, comprising:
at least two wireless access points, each of the at least two wireless access points being directly associated with a wired network and configured to provide wireless network access within an industrial facility; and
industrial equipment located within the industrial facility, wherein the industrial equipment is configured to select an individual wireless access point from the at least two wireless access points to establish a link to the wired network.

39. The system according to claim 38, wherein each of the at least two wireless access points has a unique fixed identifier.

40. The system according to claim 39, wherein the industrial equipment is configured to sequentially scan the unique fixed identifiers.

41. The system according to claim 38, wherein the industrial equipment is configured to select the individual wireless access point based upon at least one of greatest signal strength, greatest signal quality, and lowest bit-error rate.

42. The system according to claim 38, wherein the at least two wireless access points and the industrial equipment are configured to communicate using at least one of an I.E.E.E. 801.11 and a Bluetooth wireless networking protocol.

43. The system according to claim 38, wherein the wired network utilizes an Internet Protocol.

44. The system according to claim 38, wherein the industrial equipment is equipment associated with one of semiconductor fabrication, pharmaceutical manufacturing, automobile manufacturing, and food processing.

45. The system according to claim 38, wherein the industrial equipment comprises a pump.

46. A system for providing data communications over a power distribution network, comprising:
a host associated with at least one power line, the host being configured to mange a self-configuring data communications network over the at least one power line; and
a plurality of client devices associated with the at least one power line, each of the plurality of client devices being configured to communicate with the host over the at least one power line,
wherein the system is configured so that the communications from each one of the plurality of client devices are relayed through at least one other device of the plurality of client devices.

47. The system according to claim 46, wherein the host is configured to broadcast, via the at least one power line, a routing request to the plurality of client devices.

48. The system according to claim 47, wherein the host is configured to receive acknowledgement messages from the plurality of client devices in response to the routing request, wherein information contained within the acknowledgment messages is used to create a routing list.

49. The system according to claim 46, wherein each of the plurality of client devices is configured to receive a routing request, store a hop associated with the host, and rebroadcast the routing request over the network.

50. The system according to claim 46, wherein the host is configured to communicate with a specific client device based upon a routing list which contains information regarding the path to the specific client device.

51. The system according to claim 46, wherein the host is configured to communicate with a specific client device by broadcasting a message over the network, wherein the message includes an identification code uniquely associated with the client device.

52. The system according to claim 46, wherein the system is configured so that one client device communicates with another client device over the network through the host.

53. The system according to claim 46, wherein the system is configured so that one client device communicates with another client device by broadcasting a routing request and relaying a message through at least one client device to a destination device.

54. The system according to claim 46, wherein the network further comprises industrial equipment associated with at least one of the plurality of client devices.

55. The system according to claim 54, wherein the industrial equipment is equipment associated with one of semiconductor fabrication, pharmaceutical manufacturing, automobile manufacturing, and food processing.

56. The system according to claim 54, wherein the industrial equipment comprises a pump.

57. The system according to claim 46, wherein the host and the plurality of client devices communicate using the HomePlug protocol.

58. The system according to claim 46, wherein the client devices and the at least one power line are configured to provide redundancy within the network.

59. The system according to claim 46, wherein the at least one power line further comprises three-phase alternating current power lines.

60. The system according to claim 59, wherein messages are sent over each phase of the three-phase power lines.

61. The system according to claim 59, wherein messages are sent over one phase of the three-phase power lines, wherein the one phase is one of manually selected and automatically selected.

62. The system according to claim 61, wherein the client devices indicate which phase is used for message communication.

63. A system for providing data communications for industrial applications over a power distribution network, comprising:
a host device configured to manage a self-configuring network;
a plurality of client devices, communicably linked to the host device over at least one power line, wherein each of the plurality of client devices communicates with the host device using ad-hoc communication; and
industrial equipment associated with at least one of the plurality of client devices.

64. The system according to claim 63, wherein the industrial equipment is equipment associated with one of semiconductor fabrication, pharmaceutical manufacturing, automobile manufacturing, and food processing.

65. The system according to claim 63, wherein the industrial equipment comprises a pump.

66. The system according to claim 63, wherein the host device and the plurality of client devices communicate using the HomePlug protocol.

67. The system according to claim 63, wherein the client devices and the at least one power line are configured to provide redundancy within the network.

68. The system according to claim 63, wherein the at least one power line further comprises three-phase alternating current power lines.

69. The system according to claim 68, wherein communications occur over each phase of the three-phase power lines.

70. The system according to claim 68, wherein communications occur over one phase of the three-phase power lines, wherein the one phase is one of manually selected and automatically selected.

71. The system according to claim 70, wherein the client devices indicate which phase is used for communications.

72. A method for providing data communications over power lines, comprising:
initializing data communications over a power line network through self-configuration;
providing data from a source device to at least one intermediate device over the power line network; and
relaying the data from the at least one intermediate device to a destination device over the power line network.

73. The method according to claim 72, wherein the initializing further comprises:
receiving a routing request by at least one device;
storing at least one hop back to a host on the at least one device;
rebroadcasting another routing request from the at least one device;
receiving the rebroadcasted routing request by at least one other device; and
storing at least one hop back to the host on the at least one other device.

74. The method according to claim 73, wherein the rebroadcasting repeats until all devices on the power line network have received a respective routing request.

75. The method according to claim 73, wherein a first routing request originates from the host.

76. The method according to claim 75, further comprising:
appending, to an acknowledgment message, path information associated with each device;
relaying the acknowledgement message through at least one device back to the host in response to the routing request; and
creating a routing list based upon the path information.

77. The method according to claim 73, wherein the storing stores one of a first routing request received, a routing request associated with a strongest signal, and hops associated with a plurality of routing requests.

78. The method according to claim 72, wherein the source device is a host and the destination device is a client, further comprising:
appending, to the data, an identification code associated with the client; and
broadcasting the data and the identification code from the at least one intermediate device to the client.

79. The method according to claim 72, wherein the source device is a host and the destination device is a client, further comprising:
relaying the data from the host to the client through a path which includes the at least one intermediate device, wherein the path is designated by a routing list.

80. The method according to claim 72, wherein the source device is a client and the destination device is a host, further comprising:
relaying data from the client to the host through a path which includes the at least one intermediate device, wherein each hop in the path is based on information stored in each device sending the data within each hop.

81. The method according to claim 80, further comprising:
providing, from each device receiving data within each hop, an acknowledgement to each device sending data within each hop; and
determining, based upon whether the acknowledgement is received, whether the sending device will relay the data through an alternate path.

82. The method according to claim 79, further comprising:
sending an acknowledgment from the client to the host; and
determining, based upon whether the acknowledgement is received, whether the host will relay the data through an alternative path.

83. The method according to claim 82, wherein the alternative path is based upon the routing list.

84. The method according to claim 82, further comprising:
broadcasting a new routing request to the at least one intermediate device;
creating a new routing list based upon the new routing request; and
determining an alternative path based upon the new routing list.

85. The method according to claim 72, further comprising providing redundant paths throughout the power line network.

86. A system for providing redundant networking for industrial applications, comprising:
a host configured to mange data communications over a power distribution network;
at least two devices configured to communicate with the host over the power distribution network, wherein communications from each one of the devices are relayed through at least one other device of the at least two devices;
at least two wireless access points directly associated with the at least two devices and configured to provide wireless network access within an industrial facility; and
industrial equipment located within the industrial facility, wherein the industrial equipment is configured to select an individual wireless access point from the at least two wireless access points to establish a data communications link to the power distribution network.
